(19) United States
(12) Patent Application Publication
(10) Pub. No.: US 2023/0295446 A1
(43) Pub. Date: Sep. 21, 2023

(54) AN ANTI-FOULING TREATED HEAT EXCHANGER AND METHOD FOR PRODUCING AN ANTI-FOULING TREATED HEAT EXCHANGER

(71) Applicant: SIOX APS, Horsholm (DK)

(72) Inventors: Dan KOFOED, Copenhagen (DK); Annemette HINDHEDE JENSEN, Niva (DK)

(21) Appl. No.: 18/002,730

(22) PCT Filed: Jul. 1, 2020
(86) PCT No.: PCT/EP2020/068573

§ 371 Date: Dec. 21, 2022

(51) Int. Cl. C09D 5/16; C09D 7/63

(52) U.S. Cl. CPC C09D 5/1675; C09D 5/1681; C09D 7/63

(57) ABSTRACT

An anti-fouling coated heat exchanger in which the anti-fouling coating is a non- continuous silicon oxide film, and a method of making an anti-fouling coated heat exchanger in which the anti-fouling coating is a continuous or discontinuous silicon oxide film which can be formed with high smoothness on the internal surfaces of a closed heat exchanger.

### FIELD OF THE INVENTION

The present invention relates to an anti-fouling treated heat exchanger, a method for producing said heat exchanger, and the use of a silicon oxide coating for anti-fouling treatment of a heat exchanger.

### BACKGROUND OF THE INVENTION

WO2012/000500 describes the use of ceramic coatings such as SiOz on mould surfaces for polymer shaping to allow mould surfaces to be of high smoothness or bear nanostructures thereon that are replicated in the moulded article. Functionalisation of the ceramic coating with silanes is described as useful in assisting the release of the moulded article from the mould. The ceramic layer is preferably of a thickness of less than 2 micron, but the thickness measurement is made from the highest point of the surface so coated, ie the thickness does not include coating that fills depressions in the coated surface. Suitable precursors for formation of a SiOz coating are HSQ in MIBK or MSQ in MIBK, and suitable curing conditions are heating at 600° C. for 1 hour.

WO2013/083129 describes a ceramic coating for the reduction of surface roughness and corrosion prevention on items such as a heat exchanger. It is important that the coating has no, or a very low number of, pinholes therein. The method of formation of the coating uses a spin-on glass, which is then exposed to an atmosphere containing a solvent for the components of the spin-on glass such that the spin-on glass reaches a “reflow” condition in which a solution of the spin-on glass forms a continuous coating over the surface of the coated article. The continuous coating thus formed is then treated to evaporate the solvent therefrom and cured, for example by heating at above 200° C. in the presence of oxygen, or heating at 600° C. for 1 h. The coating may then be functionalized with silanes, which may improve wetting or slip where the coating is to be used on the shaping surface of a mould for polymer articles. The spin-on glass may be HSQ or MSQ.

WO2013/017132 describes an anticorrosion treatment for articles such as heat exchangers, in which the article is coated with a reactive silicon oxide precursor. Where the reactive silicon oxide precursor used is a spin-on glass, the method described in WO2013/083129 of bringing the spin-on glass to a “reflow” condition is used to form a continuous coating. Alternatively, a solution of reactive silicon oxide precursor, such as HSQ in MIBK or VMS, is applied to the article, such as by dip coating, and the excess solution poured off to leave a layer of up to 5 micron thickness on the surface of the article. The solvent in both cases is then evaporated, for example by application of vacuum or heat, to make a film that is no longer liquid, having a thickness of most preferably less than 2 micron. It is important that this film covers the whole of the surface of the article to be treated. The film is then cured and bonded to the surface of the article by heating, such as at a temperature of greater than 300° C., greater than 350° C. or greater than 400° C., with example conditions of 400° C. in air, 450° C. in an oven, 300° C., and 600° C. being mentioned. The cured film may have a thickness of 500 nm. It is disclosed that curing HSQ in air gives a Si:O ratio in the cured film of close to 2, whereas use of an inert atmosphere results in an Si:O ratio in the cured film of between 1 and 1.5. Silane functionalization of the cured coating is described.

### OBJECT OF THE INVENTION

It may be seen as an object of the present invention to provide a method for anti-fouling (anti-stiction) treatment of heat exchangers.

It is an object of the present invention to present a technological solution, where the heat transfer capabilities of the surface are less negatively affected than by other methods for anti-fouling treatment.

It is a further object of the invention to present a technological solution where the anti-fouling treatment process may be applied to complex 3D geometries without line of sight to the whole or part of the geometry to be anti-fouling treated.

It is a further object of the invention to present a technological solution where the anti-fouling treatment process also conveniently provides an adhesion layer for subsequent functionalization using silane chemistry.

It is a further object of the invention to present a technological solution where the surface roughness of the anti-fouling treated parts are reduced, and where rough surfaces may be anti-fouling treated.

It is a further object of the present invention to provide an alternative to the prior art.

### SUMMARY OF THE INVENTION

The present invention solves numerous problems in state-of-the-art industrial anti-fouling protection of heat exchangers.

The present inventors have surprisingly discovered that by reducing the surface roughness of the heat exchanger surfaces in contact with the heat exchange fluids, it is possible significantly to reduce the fouling of those surfaces. Further, it has surprisingly been discovered that this can be achieved using a silicon oxide (SiOₓ) coating which is not necessarily continuous across the whole treated surface - that is, the coating is not conformal in the sense that it covers all parts of the treated surface to the same thickness following the microscopic surface texture of that surface; it can simply be applied in the hollows and depressions of the texture of the surface to be treated without necessarily coating the raised parts of the surface texture, thus resulting in reduced surface roughness for the surface without necessarily coating it entirely or preventing the heat exchange fluids from coming into contact with every part of the original material of the treated surface. This discovery is different from the coatings previously described in connection with anticorrosion treatment of heat exchangers, in which it is considered very important to obtain a continuous coating having a minimum thickness above the highest points of the microscopic surface texture of the treated surface, and to minimize pinholes or other defects in the surface, in order to prevent contact between potentially corrosive materials and the treated surface.

In a first aspect, the present invention provides an anti-fouling treated closed heat exchanger comprising a closed heat exchanger comprising a metal surface which is brought into contact with a heat exchange fluid in use, on which metal surface is formed a non-continuous coating of silicon oxide which at least partially levels the surface microtopography of the metal surface.

Preferably, the leveling of the surface microtopography by the silicon oxide coating results in a surface roughness of lower than 90% of that of the uncoated metal surface, more preferably lower than 80% of the uncoated metal surface, more preferably lower than 70% of that of the uncoated metal surface, more preferably lower than 60% of that of the uncoated metal surface, more preferably lower than 50% of that of the uncoated metal surface, more preferably lower than 40% of that of the uncoated metal surface, even more preferably lower than 30% of that of the uncoated metal surface, even more preferably lower than 20% of that of the uncoated metal surface, even more preferably lower than 10% of that of the uncoated metal surface and most preferably lower than 5% of that of the uncoated metal surface.

Preferably, the thickness of the silicon oxide coating is below 1 µm, more preferably below 0.5 µm, more preferably below 0.2 µm, and most preferably below 0.1 µm. In the present invention, the thickness of the silicon oxide coating is measured from the lowest point of the surface microtopography of the of the metal surface to the surface of the silicon oxide coating. This is distinct from thickness measurements in some of the prior art documents discussed in the Background section, in which the measurement is made from the highest point of the surface microtopography of the metal surface.

Preferably, the ratio of Si:O in the silicon oxide coating is between 1.5 and 2, preferably between 1.6 and 1.9, more preferably between 1.7 and 1.8. While it is possible in the present invention to use a Si:O ratio below 1.5, this is not preferred as it results in discolouration to the coating which, on steel in particular, gives the impression of rust, and is not desirable. Further, it is surprisingly found by the present inventors that a Si:O ratio above 1.5 gives an improved surface smoothness for the silicon oxide coating.

Preferably, the proportion of the surface area of the metal surface which is covered by the non-continuous coating of silicon oxide is at least 70%, preferably at least 80%, and more preferably at least 90%, and is less than 100%, preferably less than 98%, more preferably less than 95%. It has surprisingly been found by the present inventors that these relatively low proportions of surface coverage are sufficient to produce a significant improvement in the degree of fouling of the heat exchanger compared with an uncoated heat exchanger.

Preferably, the surface roughness Rₐ of the non-continuous silicon oxide film is at most 100 nm measured over a distance of 5 micron. More preferably, the surface roughness Rₐ is between 100 nm and 10 nm, such as at most 80 nm or at most 60 nm.

Preferably, the metal surface is a steel surface. It has been found that the coatings of the present invention have a particular benefit on steel surfaces, in which the grain structure of the steel can produce a high microscopic surface roughness, such as a height difference between the lowers and highest areas of the surface microtopography exceeding 1 micron.

Preferably, the surface adhesion strength of mineral scaling from calcium-based salts to the surface is reduced by at least 50% compared with the uncoated metal surface, and/or the surface adhesion strength of asphaltenes is reduced by at least 50% compared with the uncoated metal surface, and/or the surface adhesion strength of a biofilm is reduced by at least 50% compared with the uncoated metal surface, and/or the surface adhesion strength of solidified salt in a molten salt melt is reduced by at least 50% compared with the uncoated metal surface.

Suitably, the heat exchanger further comprises a self-assembled monolayer of covalently bonded PEG on the silicon oxide coating, or further comprises a self-assembled monolayer of 1H,1H,2H,2H-perfluorodecyltrichlorosilane (FDTS) on the silicon oxide coating.

In a second aspect, the present invention provides a method for manufacturing of an anti-fouling treated closed heat exchanger comprising the following steps:
providing an initial uncoated closed heat exchanger comprising an internal metal surface which is brought into contact with a heat exchange fluid in use;
filling the said uncoated closed heat exchanger with a reactive silicon oxide precursor selected from Hydrogen Silsesquioxane (HSQ) or an oligomer thereof, or MSQ or an oligomer thereof, dissolved in a volatile solvent or mixture of one or more volatile solvents having a vapour pressure in the range of from 10 mbar to 200 mbar at the coating temperature;
draining the said uncoated closed heat exchanger with a linear velocity between 0.1 and 10 mm/s, thereby depositing a thin film of the reactive silicon oxide precursor dissolved in a volatile solvent on the metal surface of the said uncoated closed heat exchanger;
allowing at least one of the solvents to at least partly evaporate with a film evaporation rate above 0.5 µm/min, in order to form a continuous or discontinuous non-liquid film of reactive silicon oxide precursor on said metal surface of said closed heat exchanger;
curing said non-liquid film of reactive silicon oxide precursor by thermal curing thus converting the non-liquid film of reactive silicon oxide precursor into a continuous or discontinuous coating of silicon oxide (SiOₓ), preferably silicon dioxide.

It has surprisingly been found by the present inventors that the conditions of the filling and draining of the heat exchanger with the reactive silicon oxide precursor solution, and the solvents used, particularly their volatility, have a significant effect on the surface roughness of the cured silicon oxide coating. Further, as noted previously, the coating need not be continuous in order to provide significant improvement in the fouling of the heat exchanger. However, a continuous silicon oxide coating, formed according to the method of the present invention, is also found to have a high surface smoothness that provides a significant antifouling effect.

Preferably, in order that the surface roughness of the cured silicon oxide film is low (surface smoothness is high), the linear velocity of draining is between 0.3 and 8 mm/s, preferably between 0.5 and 5 mm/s, more preferably between 1 and 4 mm/s and most preferably between 2 and 3 mm/s. In addition, it is preferred that the film evaporation rate is above 1 µm/min, more preferably 2 µm/ min, more preferably 5 µm/min, more preferably 10 µm/min. Further, it is preferred that the closed heat exchanger is ventilated after draining with a flow of air or gas. Suitably, the flow of air or gas may be 1 L/min, or 0.5 L/min, for a time of up to 60 s, such as 30 s. It is further preferred that the filling and/or the draining of the closed heat exchanger uses a pump with a steady flow and low pulsation.

Preferably, in order to result in a silicon oxide coating with high surface smoothness, the curing is carried out by heating at a temperature of from 450° C. to 1000° C. under vacuum or in an inert or oxygen-free atmosphere.

Suitably, the coating of the metal surface with the solution of reactive silicon oxide precursor can take place at elevated temperature (ie above ambient temperature), for example by application of a heated solution and/or application of the solution to a heated metal surface, or the coating can take place at a temperature below ambient temperature, for example by application of a cooled solution and/or application of the solution to a cooled metal surface. Preferably, however, the coating is carried out at ambient temperature, as this minimizes cost and equipment.

Preferably, in order to result in a silicon oxide coating with high surface smoothness, the reactive silicon oxide precursor is provided as a solution in a volatile solvent or mixture of volatile solvents having a vapour pressure in the range of from 10 mbar to 200 mbar at ambient temperature, such as 25° C. More preferably, the volatile solvent or mixture of volatile solvents comprises at least 50% by volume of a solvent with a boiling point below 118° C. Yet more preferably, a solvent with a boiling point below 110° C. comprises at least 50% of the volatile solvent or mixture of volatile solvents by volume. Very preferably, the reactive silicon oxide precursor is provided as a solution in MIBK, or as a solution in a mixture of hexamethyldisiloxane and octamethyl trisiloxane in a proportion of from 50% to 100% hexamethyldisiloxane, preferably in a ratio of from 5:1 to 2:1 hexamethyl disiloxane to octamethyl trisiloxane.

Preferably, the reactive silicon oxide precursor is present in the solution in an amount of less than 20% by weight. It is found that this range of concentrations of reactive silicon oxide precursor allows an even coating to be formed on heat exchangers which comprise brazing, which tends to encourage the formation of thicker coating areas where concentrations of 20% by weight or higher are used.

Preferably, as in the first aspect of the invention, the metal surface is a steel surface.

Preferably, the thickness of the silicon oxide coating is less than 1 micron, preferably up to 500 nm. It has been found by the present inventors that the use of a coating of greater than 1 micron thickness can lead to the formation of cracks and flakes in the coating. The present inventors have surprisingly found that a very thin coating can be used to obtain a significant improvement in fouling of heat exchangers.

Preferably, the surface roughness Rₐ of the silicon oxide film is in the range of from 100 nm to 10 nm measured over a distance of 5 micron. Other suitable surface roughness Rₐ values are mentioned in connection with the first aspect of the invention.

Suitably, the method of the present invention may further comprise functionalization of the silicon oxide coating by formation of a self-assembled monolayer thereon. Thus, the method may further comprise the following steps:
filling the silicon oxide coated closed heat exchanger with a solution of a functionalizing agent, thereby allowing a self-assembled monolayer of functionalizing agent to form on the silicon oxide surface;
draining the coated closed heat exchanger of the solution of functionalizing agent.

Suitably, the solution of functionalizing agent is 1H,1H,2H,2H-Perfluorodecyltrichlorosilane (FDTS) dissolved in hydrofluoroether, and the self assembled monolayer is of FDTS. Alternatively, the solution of functionalizing agent is a solution of Poly Ethylene Glycol (PEG) silane, and the self-assembled monolayer is of covalently bonded PEG on the silicon oxide coating.

In a third aspect, the present invention provides the use of a continuous or discontinuous coating of SiOₓ on a surface of a heat exchanger in contact with a heat exchange fluid in use to reduce fouling of the heat exchanger surface. It has surprisingly been discovered that the use of a silicon oxide coating on a surface of a heat exchanger reduces significantly the fouling of that surface by contact with heat exchange fluids in use, whether or not the coating is a continuous coating. The coating so used may result in a heat exchanger according to the first aspect of the invention, and/or may be made according to the second aspect of the invention, and preferred features of those aspects apply also to this third aspect of the invention.

The problems solved are those of decreased heat transfer over a treated surface, decrease of fouling of the surfaces of the heat exchanger treated with the silicon oxide coating and which are in contact with heat exchange fluids in use, and difficulties in treating complex 3D geometries. To some extent, and depending on whether or not the silicon oxide coating is continuous or pinhole free, the coating can also provide protection of the metal surface from high-temperature corrosive fluids.

The present invention furthermore provides an easy way of making chemical surface functionalization using e.g. silane chemistry that can further increase the anti-fouling properties of the surface.

The invention solves these problems by coating the surface of heat exchanger surface, typically a metallic part, with a thin layer of a solution of a reactive silicon oxide precursor (rSiO-p) such as Hydrogen Silsesquioxane (HSQ) in Methyl Isobutyl Ketone (MIBK) or volatile methyl siloxanes (VMS), heating the part to a curing temperature of the rSiO-p, and after a curing time the part is coated by a thin layer of silicon oxide, which has several surprising properties in respect to anti-fouling (anti-stiction); the surface is smoothened in a way where sharp edges are rounded so that contaminants cannot adhere as well, the surface now consists of a non-porous material (where steel or other metals can have pores in between grain structures) with very limited chemical reactivity, meaning that the surface is less likely to react to contaminants in the fluid, while at the same time not reducing the heat transfer properties significantly due to the very low layer thickness of 1 µm or less.

The invention here presented regards the anti-fouling treatment of a heat exchanger, typically consisting of a metallic material. First the heat exchanger surface of the part is at least partly coated with a thin film of a solution of a reactive silicon oxide precursor (rSiO-p), preferably a solution of a silsesquioxane, more preferably a solution of Hydrogen Silsesquioxane (HSQ), forming a coated part. The coating is preferably a coating method where the surface of the heat exchanger is brought in contact with the solution of reactive silicon oxide precursor solution, after which the said solution is physically removed (e.g. by first filling the heat exchanger and then draining it) in such a way that the surface forces leave a thin film with a thickness corresponding to 1 µm or less non-liquid reactive silicon oxide precursor film. The surface of the heat exchanger may for example comprise channels or flow chambers in complex 3D geometries where traditional line-of-sight coating methods such as magnetron sputtering or spray coating may not be used. The heat exchanger is heated to an elevated temperature where the rSiO-p cross-links and forms a thin film of silicon oxide containing material and furthermore forms covalent bonds to the reactive groups of the surface of the individual parts of the assembly. For example, HSQ forms a thin layer of silicon oxide or fused silica, which is very temperature resistant and corrosion resistant at high temperatures. It is furthermore a good adhesion layer for silane chemistry.

Normal use of rSiO-p’s such as HSQ is for making electrical insulating layers in semiconductor fabrication. It is furthermore used as a negative electron or deep UV-resist. In general silicon oxide is not being used as a protection layer due to its brittleness, lack of mechanical strength and chemical inertness (which normally causes poor adhesion to the parts to be treated. However, using the disclosed method, a high mechanical strength and good adhesion is achieved.

The novelty and inventive step of using a thin film of rSiO-p for anti-fouling treatment of heat exchangers is realized by the surprisingly high decrease in fouling of the treated heat exchanger, due to the combination of chemical inertness and the reduced surface roughness.

A further desirable feature is the lowering of the surface roughness due to the coating method, reducing drag resistance in the heat exchanger channels, and the ease of postfunctionalization using silane chemistry, where SiOₓ exhibits a far higher density when forming self assembled monolayers of e.g. (1H,1H,2H,2H)-Perfluorodecyltrichlorosilane (FDTS) and Trimethoxy Silane terminated Polyethylene glycol (Si-PEG).

### DESCRIPTION OF THE INVENTION

Heat exchangers are used in many different applications where heat needs to be exchanged between two streams of fluid. Many of these fluids are not pure and will over time form a fouling layer on the surface of the heat exchanger, reducing heat transfer properties, increasing flow resistance and in the end blocking the flow completely, which may be critical in some applications. The fouling layer can consist of many different types of fouling, non-limiting examples being biofilms, mineral deposits, or organic compounds, such as oil, tar or asphaltenes.

In many of these applications the resistance to fouling of the heat exchanger may pose limitations to the use of the final device due to fouling as a result of the fluids getting in contact with the heat exchanger during use. The typical solution is to choose a different design of heat exchanger that can be disassembled and cleaned with added cost and downtime as result, or not to use a heat exchanger at all leading to increased energy consumption.

Therefore much research and effort is put into developing new anti-fouling treatments with better thermal stability, higher adhesion strength, less pin-holes and better anti-fouling properties and longer lifetime, which are all properties whose improvement are desirable. What we here disclose is the surprisingly advantageous treatment for use in anti-fouling applications of a material normally used for a very different purpose, namely electrical isolation of integrated circuits.

Silicon oxide precursors such as hydrogen or methyl silsesquioxane (HSQ or MSQ) are used in semiconductor fabrication as an electrically isolating layer and used in research applications as a negative electron beam or deep UV resist. What we have discovered here is that the chemical inertness, low film thickness and high adhesion strength to various metallic or ceramic substrates and the ability to smoothen the surface makes this material ideal for anti-fouling treatment applications due to three surprising issues; the low thickness of the layer makes the silicon oxide tough compared to silicon oxide in a bulk phase (such as quartz or fused silica glass), the low thickness ensures minimal change of thermal transfer properties of the treated part, the silicon oxide precursor is chemically reactive to various substrates under the right curing conditions, thus making stable, covalent bonds, thereby ensuring a superior adhesion strength, and the low thickness of the film also counteracts the problem of delamination caused by different thermal expansion of the substrate and the bonding layer, even though the thermal expansion coefficient of silicon oxide is very low, and that of e.g. a metallic substrate is very high. The proposed process is essentially a wet coating process, where the adhered reactive silicon oxide precursor is cured to form an inert layer of silicon oxide.

Each step will now be described in detail.

A heat exchanger consisting of a metallic material to be at least partly anti-stiction treated is brought in contact with a solution of a reactive silicon oxide precursor (rSiO-p) solution, e.g. dip coating or by filling the relevant structure with the solution (in the case of channels or flow chambers). After contact the majority of the solution is removed or poured off the channels or flow chambers. Thereby the surface of the heat exchanger is coated with a thin layer (<1 µm) of rSiO-p. At least part of the remaining solvent of the solution is allowed to evaporate until the rSiO-p is no longer liquid. This evaporation may be performed in a vacuum chamber or by heating the part to an elevated temperature below the reaction temperature of the rSiO-p, or by forced convection of gas. It is important that the whole surface to be treated of the heat exchanger surface is brought in contact with the rSiO-p solution to ensure a full (though not necessarily continuous) coating of the surface. This may be done using vacuum priming of the channels or continuous pumping to get rid of air bubbles in the channels. When this is ensured the part is heated above the reaction temperature of the rSiO-p, thus ensuring covalent cross-linking of the rSiO-p itself as well as covalent bonding to the said heat exchanger surface to be treated. The heating will typically take place in an oven, typically at 450-850° C. and in vacuum or inert/oxygen free atmosphere. After heating the heat exchanger is cooled to the desired operational temperature, and the heat exchanger is ready for use. The heat exchanger may then as an optional step be functionalized by the use of silane chemistry or other types of chemistry reacting well to silicon oxide surfaces, to further improve the anti-fouling properties of the heat exchanger surface.

The invention relates to an anti-stiction closed heat exchanger comprising at least the following parts:
An uncoated, closed heat exchanger comprising a metal surface
a non-conformal coating of silicon oxide on said uncoated closed heat exchanger metal surface, which levels the surface microtopography and is characterized by the surface roughness of the coated surface being lower than the said uncoated closed heat exchanger.

The invention furthermore relates to a closed heat exchanger where the surface roughness is lower than 90% of the uncoated heat exchanger, more preferably lower than 80% of the uncoated heat exchanger, more preferably lower than 70% of the uncoated heat exchanger, more preferably lower than 60% of the uncoated heat exchanger, more preferably lower than 50% of the uncoated heat exchanger, more preferably lower than 40% of the uncoated heat exchanger, even more preferably lower than 30% of the uncoated heat exchanger, even more preferably lower than 20% of the uncoated heat exchanger, even more preferably lower than 10% of the uncoated heat exchanger and most preferably lower than 5% of the uncoated heat exchanger.

The invention furthermore relates to a heat exchanger where the thickness of the silicon oxide layer is below 0.1 µm, more preferably below 0.2 µm, more preferably below 0.5 µm, more preferably below 1 µm, more preferably below 2 µm.

The invention furthermore relates to a method for manufacturing of a silicon dioxide coated closed heat exchanger with anti-stiction properties comprising the following steps:

Providing an initial uncoated closed heat exchanger comprising a metal surface
filling the said uncoated closed heat exchanger with Hydrogen Silsesquioxane (HSQ) or an oligomer thereof dissolved in one or more volatile solvents where a solvent with a boiling point below 110° C. comprises at least 50% of the solvents by volume.
draining the said uncoated closed heat exchanger with a linear velocity between 0.1 and 10 mm/s, more preferably between 0.3 and 8 mm/s, more preferably between 0.5 and 5 mm/s, even more preferably between 1 and 4 mm/s and most preferably between 2 and 3 mm/s thereby depositing a thin film of HSQ dissolved in a volatile solvent on the metal surface of the said uncoated closed heat exchanger where the said HSQ solution is pumped into and drained from the closed heat exchanger using a pump with a steady flow and low pulsation.
allowing at least one of the solvents to at least partly evaporate with a film evaporation rate above 0.5 µm/min, more preferably 1 µm/min, more preferably 2 µm/ min, more preferably 5 µm/min, more preferably 10 µm/min where the closed heat exchanger is ventilated after draining, with a flow of air or gas, in order to form a non-conformal film of HSQ on said metal surface of said closed heat exchanger.
curing said uncoated closed heat exchanger with said non-conformal film of HSQ by thermal curing thus converting the non-conformal film of HSQ into a non-conformal film of silicon dioxide thus providing the said silicon dioxide coated closed heat exchanger with anti-stiction properties.

The invention furthermore relates to a heat exchanger where the surface adhesion strength of mineral scaling from calcium-based salts is reduced by at least 50%.

The invention furthermore relates to a method for manufacturing of a FDTS functionalized coated closed heat exchanger with anti-stiction properties comprising the following steps:

Providing an initial uncoated closed heat exchanger comprising a metal surface
filling the said uncoated closed heat exchanger with Hydrogen Silsesquioxane (HSQ) or an oligomer thereof dissolved in one or more volatile solvents where a solvent with a boiling point below 110° C. comprises at least 50% of the solvents by volume.
draining the said uncoated closed heat exchanger with a linear velocity between 0.1 and 10 mm/s, more preferably between 0.3 and 8 mm/s, more preferably between 0.5 and 5 mm/s, even more preferably between 1 and 4 mm/s and most preferably between 2 and 3 mm/s thereby depositing a thin film of HSQ dissolved in a volatile solvent on the metal surface of the said uncoated closed heat exchanger where the said HSQ solution is pumped into and drained from the closed heat exchanger using a pump with a steady flow and low pulsation.
allowing at least one of the solvents to at least partly evaporate with a film evaporation rate above 0.5 µm/min, more preferably 1 µm/min, more preferably 2 µm/ min, more preferably 5 µm/min, more preferably 10 µm/min where the closed heat exchanger is ventilated after draining, with a flow of air or gas, in order to form a non-conformal film of HSQ on said metal surface of said closed heat exchanger.
curing said uncoated closed heat exchanger with said non-conformal film of HSQ by thermal curing thus converting the non-conformal film of HSQ into a non-conformal film of silicon dioxide thus providing a said silicon dioxide coated closed heat exchanger.
filling the silicon dioxide coated closed heat exchanger with a 1H,1H,2H,2H-Perfluorodecyltrichlorosilane (FDTS) dissolved in hydrofluoroether, thereby forming a self-assembled monolayer of covalently bonded FDTS on the silicon dioxide surface.
draining the coated closed heat exchanger for FDTS solution, thus providing said FDTS-functionalized heat exchanger with anti-stiction properties.

The invention furthermore relates to a heat exchanger where the surface adhesion strength of asphaltenes is reduced by at least 50%.

The invention furthermore relates to a method for manufacturing of a PEG functionalized coated closed heat exchanger with anti-stiction properties comprising the following steps:

Providing an initial uncoated closed heat exchanger comprising a metal surface
filling the said uncoated closed heat exchanger with Hydrogen Silsesquioxane (HSQ) or an oligomer thereof dissolved in one or more volatile solvents where a solvent with a boiling point below 110° C. comprises at least 50% of the solvents by volume.
draining the said uncoated closed heat exchanger with a linear velocity between 0.1 and 10 mm/s, more preferably between 0.3 and 8 mm/s, more preferably between 0.5 and 5 mm/s, even more preferably between 1 and 4 mm/s and most preferably between 2 and 3 mm/s thereby depositing a thin film of HSQ dissolved in a volatile solvent on the metal surface of the said uncoated closed heat exchanger where the said HSQ solution is pumped into and drained from the closed heat exchanger using a pump with a steady flow and low pulsation.
allowing at least one of the solvents to at least partly evaporate with a film evaporation rate above 0.5 µm/min, more preferably 1 µm/min, more preferably 2 µm/ min, more preferably 5 µm/min, more preferably 10 µm/min where the closed heat exchanger is ventilated after draining, with a flow of air or gas, in order to form a non-conformal film of HSQ on said metal surface of said closed heat exchanger.
curing said uncoated closed heat exchanger with said non-conformal film of HSQ by thermal curing thus converting the non-conformal film of HSQ into a non-conformal film of silicon dioxide thus providing a said silicon dioxide coated closed heat exchanger.
filling the silicon dioxide coated closed heat exchanger with a solution of Poly Ethylene Glycol (PEG) silane, thereby forming a self-assembled monolayer of covalently bonded PEG on the silicon dioxide surface.
draining the coated closed heat exchanger for PEG solution, thus providing said PEG-functionalized heat exchanger with anti-stiction properties.

The invention furthermore relates to a closed heat exchanger where the surface adhesion strength of biofilm is reduced by at least 50%.

The invention furthermore relates to a closed heat exchanger according to the invention and made according to the method of the invention, optionally including providing a FTDS self-assembled monolayer on the silicon oxide coating, where the surface adhesion strength of solidified salt in a molten salt melt is reduced by at least 50%.

By fouling is meant accumulation of an unwanted material on a solid surface to the detriment of function. Said material could be limescale, a mineral, an inorganic material, an organic material, a biofilm.

By anti-stiction is meant that fouling accumulation is delayed, limited, or prevented.

By anti-fouling is meant that fouling accumulation is delayed, limited, or prevented. Thus, “anti-fouling” and “anti-stiction” are used interchangeably herein.

By adhesion strength is meant the force required to remove a substance from mechanical contact with a surface. Such force can be measured by different tests where the substance is glued to a measurement device which measures the force acting away from the surface until the point of removal of the substance from the surface.

By non-conformal is meant that the coating has a leveling effect, by filling voids, holes, grain boundaries, or defects in a surface.

By non-continuous is meant that the coating need not form a hole-free layer covering the whole of the treated surface; for example, higher areas of the surface microtopography need not be covered by the coating, though voids and depressions are covered by the coating. “Higher” here refers to the parts of the surface that are closer to the centre of the heat exchange liquid channel formed by the surface; conversely, “lower”, “voids” and “depressions” relate to parts of the surface that are further from the centre of the heat exchange liquid channel.

By draining is meant that a liquid is removed from a closed cavity at a steady and controlled flow.

By evaporation rate is meant the rate of which a solvent of the film evaporates, thus reducing the thickness of said film over time, this thickness change measured in measured in µm/s, under the given process conditions.

By silicon oxide is meant a solid material primarily (more than 50% of the mass) of silicon and oxygen, such as SiO or SiO₂. In general the stochiometric ratio between silicon and oxygen in the silicon oxide (Si:O) will be between 1:1.5 and 1:2 (e.g. silicon oxide formed by curing of HSQ in inert atmosphere at high temperature has a ratio of Si:O within this range of close to 1:1.5, whereas silicon dioxide formed from HSQ in oxygen atmosphere may have a ratio close to 1:2 (Si:O)).

By coating is meant the application of the reactive silicon oxide precursor onto the surface of the part. This may be done by submerging the part in a solution of the rSiO-p or pouring the rSiO-p solution into the desired geometry of the part, then removing excess rSiO-p solution and allowing the remaining solvent to evaporate, leaving a thin film of rSiO-p. It may also be done using other coating techniques, such as spray coating where the liquid solution of reactive silicon oxide precursor is sprayed on a surface, forming either a thin, dense film, or forming a thin film of individual particles. In the case of a film of particles, this may be transformed into a dense film by subjecting the part to an atmosphere containing vapor of a suitable solvent, e.g. MIBK or VMS, which will be absorbed by the particles until the particles dissolve and flow together to form a dense liquid film. Subsequently the part is placed in an atmosphere with no or less solvent vapor, whereby the liquid film becomes solid. All three coating methods ensure that, compared with vacuum deposition techniques, the coating reduced surface roughness in a reliable way. A vulnerability of vacuum deposition techniques is the difficulty in coating non-smooth surfaces, where the surface roughness gives rise to shadow effect on the surface leading to imperfect coating and thus failure of the coating to reduce surface roughness by filling the voids and depressions therein.

By treatment areas is meant the surface areas of a part which will be coated with rSiO-p and thus subsequently silicon oxide.

By corrosion is meant the disintegration of an engineered material into its constituent atoms due to chemical reactions with its surroundings. It may e.g. refer to electrochemical oxidation of metals in reaction with an oxidant such as oxygen or the degradation of ceramic surfaces such as the reaction of Al₂O₃ with HCl in aqueous solution.

By corrosion resistant is meant a surface not being degraded by corrosive agents, such as oxidizing agents, strong acids or strong alkali solutions.

By surface roughness is meant the vertical deviations of a real surface from its desired primary or macroscopic form. Large deviations defines a rough surface, low deviations define a smooth surface. Roughness can be measured through surface metrology measurements. Surface metrology measurements provide information on surface geometry. These measurements allow for understanding of how the surface is influenced by its production history, (e.g., manufacture, wear, fracture) and how it influences its behavior (e.g., adhesion, gloss, friction).

Surface primary form is herein referred as the over-all desired shape of a surface, in contrast with the undesired local or higher-spatial frequency variations in the surface dimensions.

Roughness measurements can be achieved by contact techniques, e.g. by use of profilometers or atomic force microscope (AFM), or by non-contact techniques, e.g. optical instruments such as interferometers or confocal microscopes. Optical techniques have the advantages of being faster and not invasive, i.e. they do physically touch the surface which cannot therefore be damaged by carrying out the measurement.

Surface roughness values herein referred are Rₐ values, ie the arithmetical mean roughness value, which is the arithmetical mean of the absolute values of the profile deviations from the mean line of the roughness profile over a given distance, here 5 micron.

By adhesion layer is meant a layer between a part and a desired surface coating with chemical and physical characteristics allowing both chemical compatibility with the part and the surface coating. An example is the use of silicon oxide or aluminum oxide as adhesion layer for adhering silanes to stainless steel. The steel itself does not have sufficient reactive —OH groups to bind the silane, and hence a layer of silicon oxide or aluminum oxide is used as an intermediate layer between the steel and the silane coating.

By silane chemistry is meant the covalent coupling of an arbitrary chemical substance to a surface through the use of a silane group. The substance designated by R will in its silanized form be designated by R-Si(x)₃ where x will typically be a chloride or methyl group. The reaction with a surface -OH group will be of the type R-Si(x)₃ + Surface-OH - > Surface-O-Si(x)₂-R + HX. This process may be performed as a gas-phase process (as done in chemical vapor deposition (CVD) or molecular vapor deposition (MVD)) or as a liquid reaction where the silane-coupled substance is brought into contact with the surface to be coated, where the surface is then spontaneously being coated with a self-assembled monolayer of the desired silane R-Si(x)₃.

By MIBK is meant methyl isobutyl ketone.

By VMS is meant a volatile methyl-siloxane.

By FDTS is meant (1H,1H,2H,2H)-Perfluorodecyltrichlorosilane.

By heating to the reaction temperature is meant the process of transforming the reactive silicon oxide precursor into the corresponding solid silicon oxide. This is typically done heating in an oven to a given temperature causing covalent cross-linking of smaller molecular entities into a mesh or grid structure, forming a solid silicon oxide.

By the thickness of the silicon oxide coating is meant the distance from the lowest point of any void or depression in the surface microtopography of the metal surface that is covered by the silicon oxide coating, to the highest point of the silicon oxide coating applied to that surface.

### BRIEF DESCRIPTION OF THE FIGURES

The part and method according to the invention will now be described in more detail with regard to the accompanying figures. The figures show one way of implementing the present invention and is not to be construed as being limiting to other possible embodiments falling within the scope of the attached claim set.

FIG. 1a shows a schematic drawing of a cross-section of an initial surface.

FIG. 1b shows a schematic drawing of a cross-section of a surface (11) where a coating layer (12) has been formed, using the described method. FIG. 1c shows a schematic drawing of a cross-section of a surface of a brazed heat exchanger, where the brazing material (13) partially covers the initial surface, and the silicon oxide coating, covers the initial surface and the brazing material.

FIGS. 2a and 2b show schematic drawings of a cross-section of an initial surface (21) where the surface roughness (24) has been lowered through the deposition of the coating layer (22), such as silicon oxide, using the described method to yield a lower final surface roughness (25). In FIG. 2a, the coating layer (22) is a continuous layer, in that all of the initial surface (21) is coated. However, in FIG. 2b, the coating layer (22) is discontinuous (non-continuous), as the voids in the initial surface (21) are partially filled, thus reducing the initial surface roughness (24) to the lower value (25), corresponding to the initial surface roughness (24) minus the layer thickness (26) of layer (22).

FIG. 3 shows a schematic drawing of a heat exchanger (31) comprising internal areas to be anti-fouling treated. A liquid precursor (34) is pumped into the heat exchanger, with a certain pumping speed (33). Inside the heat exchanger, the level of the liquid precursor changes with a certain linear velocity (32), in relation to the interior wall of the heat exchanger.

FIG. 4 shows a schematic drawing of a heat exchanger (41), where a gas (42) is pumped through the heat exchanger at a certain velocity.

FIG. 5a shows a schematic drawing of the liquid precursor as it forms on the surface (51) of the heat exchanger during the draining process, with an initial thickness (52). FIG. 5b shows the thickness (53) of the solidified (non-liquid) precursor layer after the solvent has evaporated. The evaporation rate is defined as the change in coating layer thickness over time.

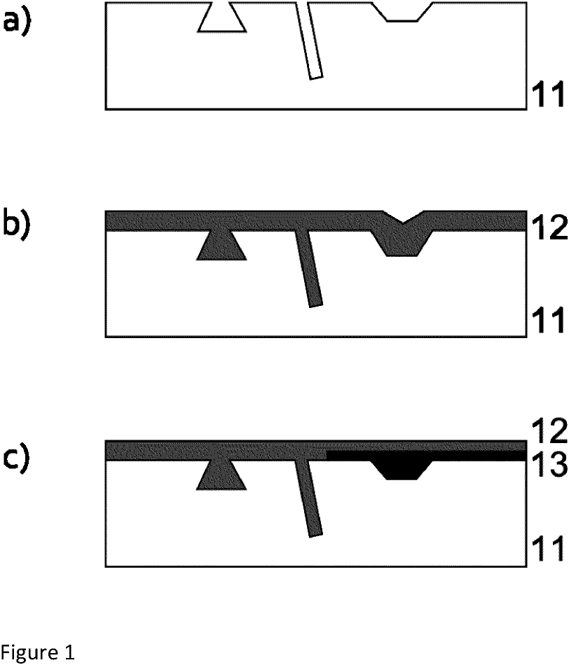

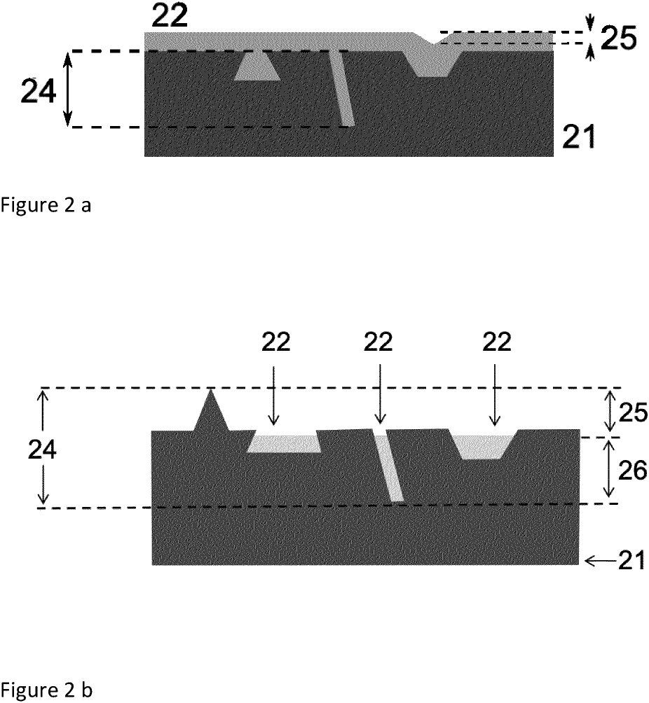

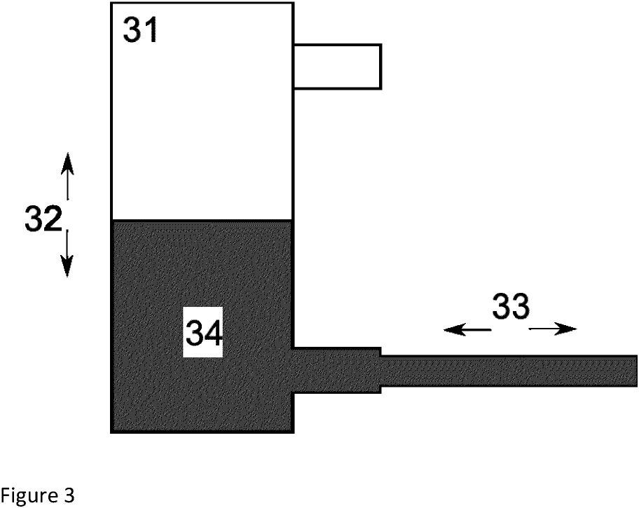

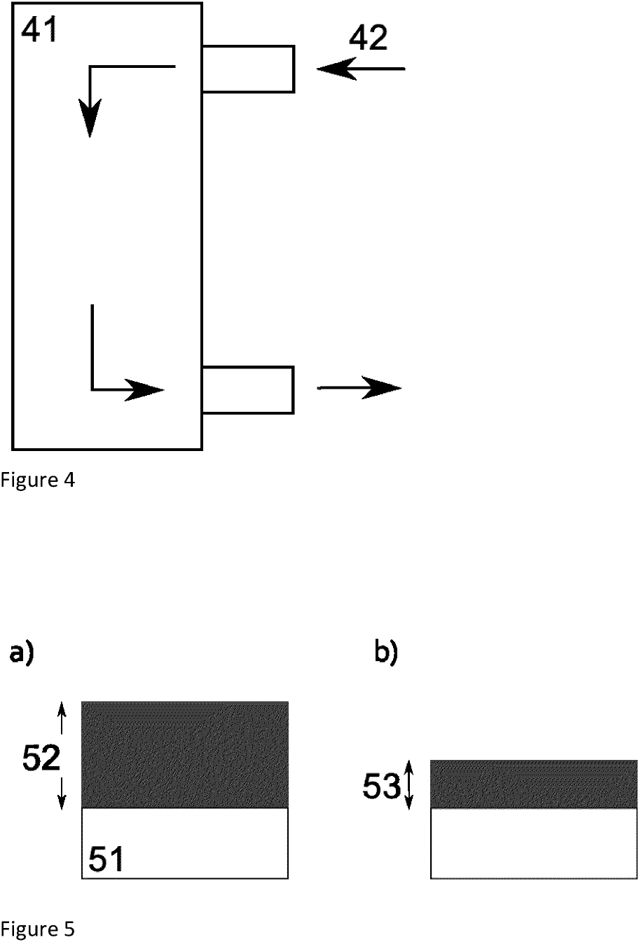

### DETAILED DESCRIPTION OF AN EMBODIMENT

### Example 1

In an example, a closed heat exchanger was filled with a liquid ceramic precursor, where the solvent was 5:1 hexamethyldisiloxane:octamethyltrisiloxane, and the solid content of HSQ was 5 wt%. The liquid precursor was drained from the heat exchanger using a phase compensation peristaltic pump, with a pumping speed so that the linear velocity of the draining speed was 1 mm/s. When drained, the heat exchanger was flushed with a stream of air, at a flow of 1 liter/min, for 60 seconds. The heat exchanger was then cured at 700° C. for 2 hours in a nitrogen atmosphere.

A non-continuous smooth (uniform) film with an average thickness of 200 nm was formed on all inside surfaces of the heat exchanger.

### Example 2

In an example, a closed heat exchanger was filled with a liquid ceramic precursor, where the solvent was MIBK, and the solid content of HSQ was 10 wt%. The liquid precursor was drained from the heat exchanger using a phase compensation peristaltic pump, with a pumping speed so that the linear velocity of the draining speed was 10 mm/s. When drained, the heat exchanger was flushed with a stream of air, at a flow of 1 liter/min, for 60 seconds. The heat exchanger was then cured at 700° C. for 2 hours in an argon atmosphere.

A non-continuous smooth (uniform) film with an average thickness of 500 nm was formed on all inside surfaces of the heat exchanger.

### Example 3

In an example, a closed heat exchanger was filled with a liquid ceramic precursor, where the solvent was 2:1 hexamethyldisiloxane:octamethyltrisiloxane, and the solid content of HSQ was 20 wt%. The liquid precursor was drained from the heat exchanger using a phase compensation peristaltic pump, with a pumping speed so that the linear velocity of the draining speed was 1 mm/s. When drained, the heat exchanger was flushed with a stream of air, at a flow of 0.5 liter/min, for 30 seconds. The heat exchanger was then cured at 1000° C. for 2 hours in vacuum. A non-continuous smooth (uniform) film with an average thickness of 1000 nm was formed on all inside surfaces of the heat exchanger.

### Example 4

In an example, a copper brazed heat exchanger is filled with a liquid ceramic precursor, where the solvent is 2:1 hexamethyldisiloxane:octamethyltrisiloxane, and the solid content of HSQ is 15 wt%. The liquid precursor is drained from the heat exchanger using a phase compensation peristaltic pump, with a pumping speed so that the coating speed is 1 mm/s. The heat exchanger is then cured at 700° C. for 2 hours in a nitrogen atmosphere.

A non-continuous smooth (uniform) film with an average thickness of 1000 nm is formed on all inside surfaces of the heat exchanger.

### Comparative Example 1

In a comparative example, a copper brazed heat exchanger was filled with a liquid ceramic precursor, where the solvent was 1:3 hexamethyldisiloxane:octamethyltrisiloxane, and the solid content of HSQ was 20 wt%. The liquid precursor was drained from the heat exchanger using a phase compensation peristaltic pump, with a pumping speed so that the coating speed was 1 mm/s. The heat exchanger was then cured at 700° C. for 2 hours in a nitrogen atmosphere.

A non-uniform silica film had formed mainly around the brazing points. Around the brazing points the thickness of the silica layer was up to 2 µm. On other surfaces inside the heat exchanger, the thickness was below 100 nm. This is attributed to the concentration of the reactive silicon oxide precursor (liquid ceramic precursor) in the coating solution used. The surface energy of the solution at this concentration is believed not to allow the solution to form a highly smooth coating in the vicinity of the brazing points.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

All patents and non-patent references cited in the present application are also hereby incorporated by reference in their entirety.

1. An anti-fouling treated closed heat exchanger comprising a closed heat exchanger comprising a metal surface which is brought into contact with a heat exchange fluid in use, on which surface is formed a non-continuous coating of silicon oxide which at least partially levels the surface microtopography of the metal surface.

2. A-The anti-fouling treated closed heat exchanger according to claim 1, wherein the leveling of the surface microtopography by the silicon oxide coating results in a surface roughness of lower than 90% of that of the uncoated metal surface.

3. A-The anti-fouling treated closed heat exchanger according to claim 1 wherein the thickness of the silicon oxide coating is below 1 µm.

4. A-The anti-fouling treated closed heat exchanger according to claim 1, wherein the ratio of Si:O in the silicon oxide coating is between 1.5 and 2.

5. A-The anti-fouling treated closed heat exchanger according to claim 1, wherein the proportion of the surface area of the metal surface which is covered by the non-continuous coating of silicon oxide is at least 70% and is less than 100% .

6. The anti-fouling treated closed heat exchanger according to claim 1, wherein the surface roughness Ra of the non-continuous silicon oxide film is at most 100 nm measured over a 5 micron distance.

7. A-The anti-fouling treated closed heat exchanger according to claim 1, wherein the metal surface is a steel surface.

8-10. (canceled)

11. A-The anti-fouling treated closed heat exchanger according to claim 40, wherein the heat exchanger further comprises a self-assembled monolayer of covalently bonded PEG on the silicon oxide coating.

12. (canceled)

13. The anti-fouling treated closed heat exchanger according to claim 40, wherein the heat exchanger further comprises a self-assembled monolayer of 1H,1H,2H,2H-perfluorodecyltrichlorosilane (FDTS) on the silicon oxide coating.

14-30. (canceled)

31. The anti-fouling treated closed heat exchanger according to claim 4, wherein the ratio of Si:O in the silicon oxide coating is between 1.6 and 1.9.

32. The anti-fouling treated closed heat exchanger according to claim 31, wherein the ratio of Si:O in the silicon oxide coating is between 1.7 and 1.8.

33. The anti-fouling treated closed heat exchanger according to claim 5, wherein the proportion of the surface area of the metal surface which is covered by the non-continuous coating of silicon oxide is at least 80% and less than 98%.

34. The anti-fouling treated closed heat exchanger according to claim 33, wherein the proportion of the surface area of the metal surface which is covered by the non-continuous coating of silicon oxide is at least 90% and less than 95%.

35. The anti-fouling treated closed heat exchanger according to claim 3 wherein the thickness of the silicon oxide coating is below 0.5 µm.

36. The anti-fouling treated closed heat exchanger according to claim 35 where the thickness of the silicon oxide coating is below 0.1 µm.

37. The anti-fouling treated closed heat exchanger according to claim 2, wherein the leveling of the surface microtopography by the silicon oxide coating results in a surface roughness of lower than 50% of that of the uncoated metal surface.

38. The anti-fouling treated closed heat exchanger according to claim 37, wherein the leveling of the surface microtopography by the silicon oxide coating results in a surface roughness of lower than 20% of that of the uncoated metal surface.

39. The anti-fouling treated closed heat exchanger according to claim 38, wherein the leveling of the surface microtopography by the silicon oxide coating results in a surface roughness of lower than 5% of that of the uncoated metal surface.

40. The anti-fouling treated closed heat exchanger according to claim 1,
wherein the surface adhesion strength of mineral scaling from a calcium-based salt to the surface is reduced by at least 50%,
wherein the surface adhesion strength of an asphaltene to the surface is reduced by at least 50% compared with the uncoated metal surface,
wherein the surface adhesion strength of a biofilm to the surface is reduced by at least 50% compared with the uncoated metal surface, or
wherein the surface adhesion strength of a solidified salt in a molten salt melt to the surface is reduced by at least 50% compared with the uncoated metal surface.
